(19) United States
(12) Patent Application Publication
(10) Pub. No.: US 2017/0253080 A1
(43) Pub. Date: Sep. 7, 2017

(54) TOOL ASSEMBLY

(71) Applicant: Rudolph Colin KLIEN, Brooklin (CA)

(72) Inventor: Rudolph Colin KLIEN, Brooklin (CA)

(21) Appl. No.: 15/058,562

(22) Filed: Mar. 2, 2016

(51) Int. Cl. B60B 29/00; B25B 13/48

(52) U.S. Cl. CPC B60B 29/003; B25B 13/48

(57) ABSTRACT

An apparatus includes a tool assembly. The tool assembly includes a tool device configured to securely receive, at least in part, a nut. An angled elbow assembly is configured to be positioned proximate to, and securely integrally extended from, the tool device. A linearly-extended elongated shaft portion is configured to have a first end portion and a second end portion spaced apart from the first end portion. A step-pad assembly includes a first side portion facing the second end portion of the linearly-extended elongated shaft portion. A second side portion is configured to extend from the first side portion. The linearly-extended elongated shaft portion does not extend through the step-pad assembly and out from the second side portion of the step-pad assembly.

### TECHNICAL FIELD

This document relates to the technical field of (and is not limited to) an apparatus including a tool assembly having a tool device configured to securely receive, at least in part, a nut.

### BACKGROUND

A nut (threaded nut) is a type of a fastener used with a threaded bolt. A tool is configured to receive and rotate the nut on the bolt (such as a lug wrench, etc.).

### SUMMARY

It will be appreciated that there exists a need to mitigate (at least in part) at least one problem associated with the existing tool assemblies (also called the existing technology). After much study of the known systems and methods with experimentation, an understanding of the problem and its solution has been identified and is articulated as follows:

The problem with existing tool assemblies is that, sometimes, the nut (threaded nut) is very difficult to remove (loosen) from the threaded bolt.

What is needed is a tool that is configured to receive and rotate the nut on the threaded bolt for those cases where the nut (threaded nut) is overtightened on the threaded bolt (because the nut is very difficult to remove from the threaded bolt).

To mitigate, at least in part, at least one problem associated with the existing technology, there is provided (in accordance with a major aspect) an apparatus that includes a tool assembly. The tool assembly includes a tool device configured to securely receive, at least in part, a nut. An angled elbow assembly is configured to be positioned proximate to, and securely integrally extended from, the tool device. A linearly-extended elongated shaft portion is configured to have a first end portion and a second end portion spaced apart from the first end portion. A step-pad assembly includes a first side portion facing the second end portion of the linearly-extended elongated shaft portion. A second side portion is configured to extend from the first side portion. The linearly-extended elongated shaft portion does not extend through the step-pad assembly and out from the second side portion of the step-pad assembly. A technical effect for this arrangement, from amongst many such technical effects) is that the user safety of the apparatus is improved (at least in part) in such a way that the user of the apparatus reduces inadvertent injury or unwanted entanglement with the user (for the case where the linearly-extended elongated shaft portion does not extend through the step-pad assembly and out from the second side portion of the step-pad assembly).

Other aspects are identified in the claims.

Other aspects and features of the non-limiting embodiments may now become apparent to those skilled in the art upon review of the following detailed description of the non-limiting embodiments with the accompanying drawings.

This Summary is provided to introduce concepts in simplified form that are further described below in the Detailed Description. This Summary is not intended to identify key features or essential features of the disclosed or claimed subject matter, and is not intended to describe each disclosed embodiment or every implementation of the disclosed or claimed subject matter, and is not intended to be used as an aid in determining the scope of the claimed subject matter. Many other novel advantages, features, and relationships will become apparent as this description proceeds. The figures and the description that follow more particularly exemplify illustrative embodiments.

### BRIEF DESCRIPTION OF THE DRAWINGS

The non-limiting embodiments may be more fully appreciated by reference to the following detailed description of the non-limiting embodiments when taken in conjunction with the accompanying drawings, in which:

FIG. 1 depicts a perspective view of an embodiment of an apparatus including a tool assembly;

FIG. 2 and FIG. 3 depict side views of embodiments of the apparatus of FIG. 1;

FIG. 4 depicts a top view of an embodiment of the apparatus of FIG. 1;

FIG. 5 and FIG. 6 depict a top view and a cross-sectional view (respectively) of embodiments of the apparatus of FIG. 1;

FIG. 7 depicts a top view of an embodiment of the apparatus of FIG. 1;

FIG. 8 depicts a top view of an embodiment of the apparatus of FIG. 1;

FIG. 9 depicts a top view of an embodiment of the apparatus of FIG. 1;

FIG. 10 and FIG. 11 depict side views of embodiments of the apparatus of FIG. 1;

FIG. 12 and FIG. 13 depict side views of embodiments of the apparatus of FIG. 1;

FIG. 14 depicts a frontal perspective view of an embodiment of the apparatus of FIG. 1; and

FIG. 15 and FIG. 16 depict frontal perspective views of embodiments of the apparatus of FIG. 1.

The drawings are not necessarily to scale and may be illustrated by phantom lines, diagrammatic representations and fragmentary views. In certain instances, details unnecessary for an understanding of the embodiments (and/or details that render other details difficult to perceive) may have been omitted.

Corresponding reference characters indicate corresponding components throughout the several figures of the drawings. Elements in the several figures are illustrated for simplicity and clarity and have not been drawn to scale. The dimensions of some of the elements in the figures may be emphasized relative to other elements for facilitating an understanding of the various disclosed embodiments. In addition, common, but well-understood, elements that are useful or necessary in commercially feasible embodiments are often not depicted to provide a less obstructed view of the embodiments of the present disclosure.

### LISTING OF REFERENCE NUMERALS USED IN THE DRAWINGS

102 tool assembly

104 tool device

105 rotation axis

106 angled elbow assembly

107 pivot axis

108 linearly-extended elongated shaft portion

109 predetermined angle

110 first end portion

112 second end portion

114 step pad assembly

116 first side portion

118 second side portion

120 bore

122 collar portion

124 connector

126 hole

128 spaced apart projections

900 nut

904 wheel bolt

906 wheel

910 torque

912 foot

### DETAILED DESCRIPTION OF THE NON-LIMITING EMBODIMENT(S)

The following detailed description is merely exemplary and is not intended to limit the described embodiments or the application and uses of the described embodiments. As used, the word “exemplary” or “illustrative” means “serving as an example, instance, or illustration.” Any implementation described as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure. The scope of the invention is defined by the claims. For the description, the terms “upper,” “lower,” “left,” “rear,” “right,” “front,” “vertical,” “horizontal,” and derivatives thereof shall relate to the examples as oriented in the drawings. There is no intention to be bound by any expressed or implied theory in the preceding Technical Field, Background, Summary or the following detailed description. It is also to be understood that the devices and processes illustrated in the attached drawings, and described in the following specification, are exemplary embodiments (examples), aspects and/or concepts defined in the appended claims. Hence, dimensions and other physical characteristics relating to the embodiments disclosed are not to be considered as limiting, unless the claims expressly state otherwise. It is understood that the phrase “at least one” is equivalent to “a”. The aspects (examples, alterations, modifications, options, variations, embodiments and any equivalent thereof) are described regarding the drawings. It should be understood that the invention is limited to the subject matter provided by the claims, and that the invention is not limited to the particular aspects depicted and described.

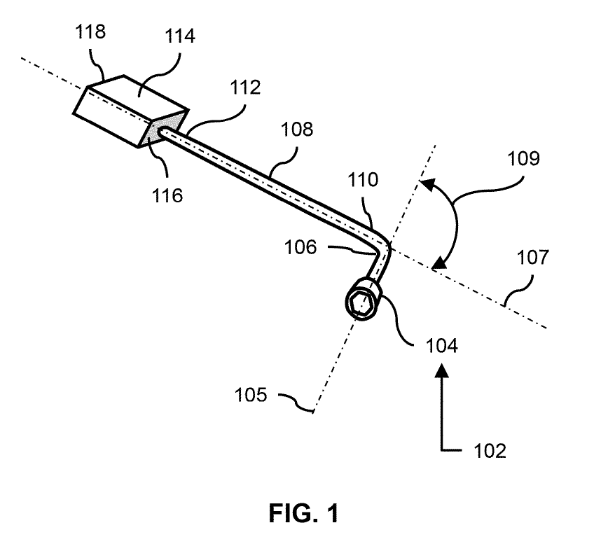

FIG. 1 depicts a perspective view of an embodiment of an apparatus including a tool assembly 102.

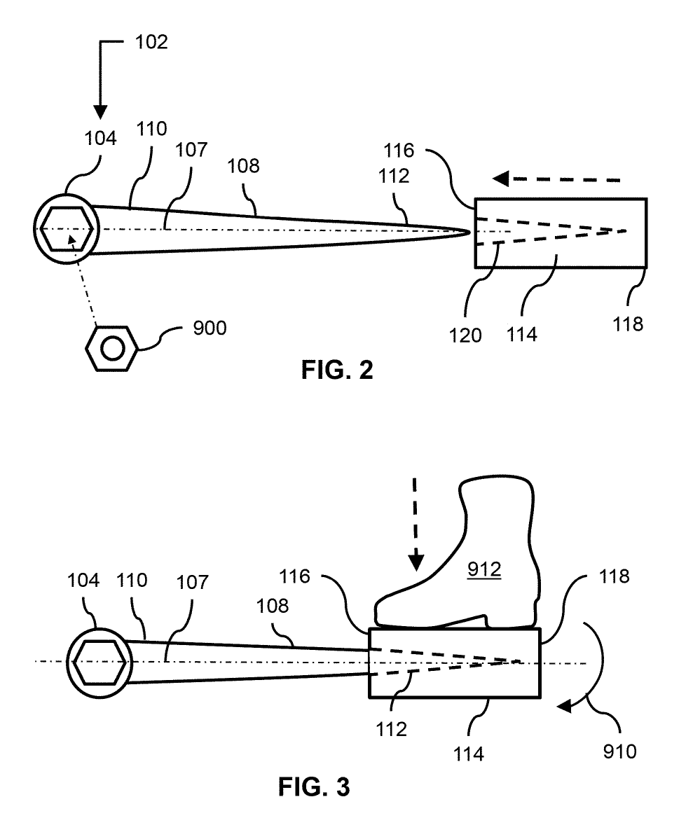

FIG. 2 and FIG. 3 depict side views of embodiments of the apparatus of FIG. 1.

In accordance with a first major embodiment as depicted in FIGS. 1 to 3, the apparatus includes (and is not limited to) a tool assembly 102. The tool assembly 102 may be included, for instance, in a lug wrench, etc., and any equivalent thereof. The tool assembly 102 includes a synergistic combination of a tool device 104, an angled elbow assembly 106, a linearly-extended elongated shaft portion 108, and a step-pad assembly 114.

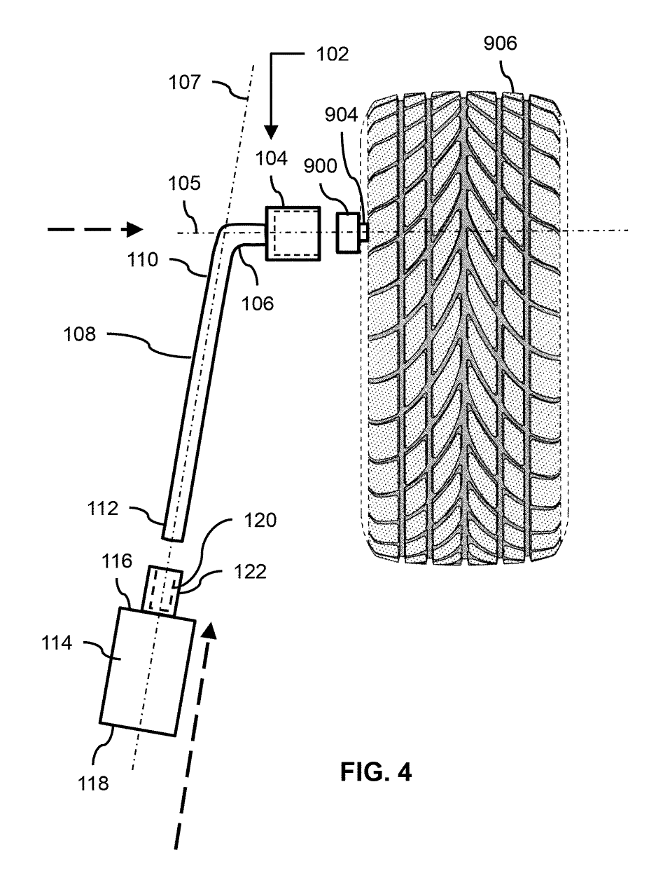

The tool device 104 is configured to securely receive, at least in part, a nut 900. It will be appreciated that the nut 900 may include, for instance, a wheel nut mounted to a wheel bolt 904 of a wheel 906 of a vehicle (known and not depicted), as depicted in FIGS. 4 to 13.

The angled elbow assembly 106 is configured to be positioned proximate to, and securely integrally extended from, the tool device 104. The angled elbow assembly 106 may include an angled elbow portion (a single-piece assembly).

The linearly-extended elongated shaft portion 108 is configured to have a first end portion 110 and a second end portion 112 spaced apart from the first end portion 110.

The step-pad assembly 114 includes a first side portion 116 and a second side portion 118. The first side portion 116 faces the second end portion 112 of the linearly-extended elongated shaft portion 108. The second side portion 118 is configured to extend from the first side portion 116 (this is done in such a way that the linearly-extended elongated shaft portion 108 does not extend through the step-pad assembly 114 and out from the second side portion 118 of the step-pad assembly 114). A technical effect for this arrangement, from amongst many such technical effects) is that the user safety of the apparatus is improved (at least in part) in such a way that the user of the apparatus 100 reduces inadvertent injury or unwanted entanglement with the user (for the case where the linearly-extended elongated shaft portion does not extend through the step-pad assembly and out from the second side portion of the step-pad assembly 114).

In accordance with a second major embodiment as depicted in FIGS. 1 to 3, the apparatus includes (and is not limited to) a tool assembly 102. The tool assembly 102 may be included in a lug wrench, etc., and any equivalent thereof. The tool assembly 102 includes a synergistic combination of a tool device 104, an angled elbow assembly 106, a linearly-extended elongated shaft portion 108, and a step-pad assembly 114.

The tool device 104 is configured to have a rotation axis 105 extending through the tool device 104, in which the tool device 104 is rotatable about the rotation axis 105. The tool device 104 is also configured to securely receive, at least in part, a nut 900 mounted to a wheel bolt 904 of a wheel 906 of a vehicle. The tool device 104 is also configured to rotate (such as, tighten and loosen) the nut 900 mounted to the wheel bolt 904 in response to rotation of the tool device 104 about the rotation axis 105 of the tool device 104.

The angled elbow assembly 106 is configured to be positioned proximate to, and securely integrally extended from, the tool device 104 in such a way that the rotation axis 105 of the tool device 104 extends, at least in part, through the angled elbow assembly 106. The angled elbow assembly 106 is also configured to have a pivot axis 107 extending therefrom (this is done in such a way that the pivot axis 107 and the rotation axis 105 of the tool device 104 intersect each other at a predetermined angle 109).

The linearly-extended elongated shaft portion 108 is configured to have a first end portion 110 and a second end portion 112 spaced apart from the first end portion 110. The first end portion 110 securely integrally extends from the angled elbow assembly 106 along the pivot axis 107 of the angled elbow assembly 106.

The step-pad assembly 114 is configured to extend from the second end portion 112 of the linearly-extended elongated shaft portion 108 along the pivot axis 107 extending through the linearly-extended elongated shaft portion 108 (this is done in such a way that the step-pad assembly 114 is extended and aligned in-line with the pivot axis 107 extending through the linearly-extended elongated shaft portion 108).

The step-pad assembly 114 is also configured to axially receive the second end portion 112 of the linearly-extended elongated shaft portion 108, in which the second end portion 112 is spaced apart from the angled elbow assembly 106. The step-pad assembly 114 is also configured to securely receive an application of a torque 910 from a foot 912 of a user in such a way that the step-pad assembly 114 securely receives the torque 910 from the foot 912 of the user without inadvertent slippage between the foot 912 of the user and the step-pad assembly 114.

The step-pad assembly 114 is also configured to securely receive the application of the torque 910 from the foot 912 of the user. This is done in such a way that the step-pad assembly 114 conveys the torque 910, which was received from the foot 912 of the user, to the linearly-extended elongated shaft portion 108, without inadvertent slippage between the foot 912 of the user and the step-pad assembly 114 (while the torque 910 is transmitted to the linearly-extended elongated shaft portion 108).

The step-pad assembly 114 is also configured to securely receive the application of the torque 910 from the foot 912 of the user. This is done in such a way that (A) the linearly-extended elongated shaft portion 108 is rotatable, once the torque 910 is received from the step-pad assembly 114 (about the pivot axis 107), and (B) the angled elbow assembly 106, and the tool device 104 and the nut 900, which is received by the tool device 104, rotate (without inadvertent slippage between the foot 912 of the user and the step-pad assembly 114 (while the linearly-extended elongated shaft portion 108 rotates about the pivot axis 107, and while the angled elbow assembly 106 and the tool device 104 and the nut 900, which is received by the tool device 104, rotate).

The step-pad assembly 114 includes (and is not limited to) a first side portion 116 facing the second end portion 112 of the linearly-extended elongated shaft portion 108. A second side portion 118 is spaced apart from the first side portion 116. The second side portion 118 is positioned opposite from the first side portion 116 across from the step-pad assembly 114. The second side portion 118 faces away from the second end portion 112 of the linearly-extended elongated shaft portion 108. The second end portion 112 of the linearly-extended elongated shaft portion 108 is configured to extend from the first side portion 116 (this is done in such a way that the linearly-extended elongated shaft portion 108 does not extend through the step-pad assembly 114 and out from the second side portion 118 of the step-pad assembly 114).

Referring to the embodiments as depicted in FIGS. 2 and 3, the step-pad assembly 114 includes a first side portion 116, and a second side portion 118 spaced apart from the first side portion 116. The step-pad assembly 114 defines or provides a bore 120 that extends partway into the step-pad assembly 114 (partway into the body of the step-pad assembly 114). The bore 120 extends from the first side portion 116 of the step-pad assembly 114 and into the interior of the step-pad assembly 114, and does not extend and reach the second side portion 118 of the step-pad assembly 114. The second end portion 112 of the linearly-extended elongated shaft portion 108 is configured to be received (at least in part) into the bore 120 of the step-pad assembly 114. Preferably, the second end portion 112 of the linearly-extended elongated shaft portion 108 is configured to be slidably received (at least in part) into the bore 120 of the step-pad assembly 114. More preferably, the second end portion 112 of the linearly-extended elongated shaft portion 108 defines a tapered end section, and the bore 120 defines a tapered shape that corresponds (conforms) to the shape of the tapered end section of the second end portion 112. More preferably, the second end portion 112 provides the tapered end section that is configured to be friction fitted (wedge fitted) with the bore 120 of the step-pad assembly 114. More preferably, the second end portion 112 may be permanently affixed (connected or attached) to the step-pad assembly 114 (such as, by welding, a connector, by gluing, etc., and any equivalent thereof).

In accordance with the embodiments as depicted in FIGS. 1 to 3, the step-pad assembly 114 includes a unitary solid body member having a width, height and length, and the unitary solid body member has a top surface and a bottom surface defining the height of the solid body member, in which the height of the unitary solid body member of the step-pad assembly 114 is any one of (A) equal to and (B) greater than the height (or diameter) of the linearly-extended elongated shaft portion 108.

FIG. 4 depicts a top view of an embodiment of the apparatus of FIG. 1.

In accordance with the embodiment as depicted in FIG. 4, the tool assembly 102 includes a two-piece configuration, which is suitable for the retrofit market. For instance, the step-pad assembly 114 may be sold as an item to be attached to an existing instance of a lug wrench. For this case, the tool assembly 102 includes the step-pad assembly 114 configured for use with (A) the tool device 104 configured to securely receive, at least in part, the nut 900, (B) the angled elbow assembly 106 configured to be positioned proximate to, and securely integrally extended from, the tool device 104, and (C) the linearly-extended elongated shaft portion 108 configured to have the first end portion 110 and the second end portion 112 spaced apart from the first end portion 110.

In accordance with an option, it will be appreciated that the step-pad assembly 114 may be fixedly attached to the linearly-extended elongated shaft portion 108 (and is not intended to be detachable from the linearly-extended elongated shaft portion 108). For instance, the step-pad assembly 114, the linearly-extended elongated shaft portion 108, the angled elbow assembly 106, and the tool device 104 are all manufactured by a metal casting process.

In accordance with a preferred embodiment, the step-pad assembly 114, the linearly-extended elongated shaft portion 108, the angled elbow assembly 106, and the tool device 104 form a continuous and unitary assembly.

In accordance with the embodiment as depicted in FIG. 4, the step-pad assembly 114 includes a collar portion 122 that extends outwardly from the step-pad assembly 114. The collar portion 122 is configured to receive the second end portion 112 of the linearly-extended elongated shaft portion 108. The collar portion 122 defines the bore 120, and the step-pad assembly 114 does not define the bore 120. The second end portion 112 of the linearly-extended elongated shaft portion 108 is configured to be received, at least in part, into the bore 120 of the collar portion 122.

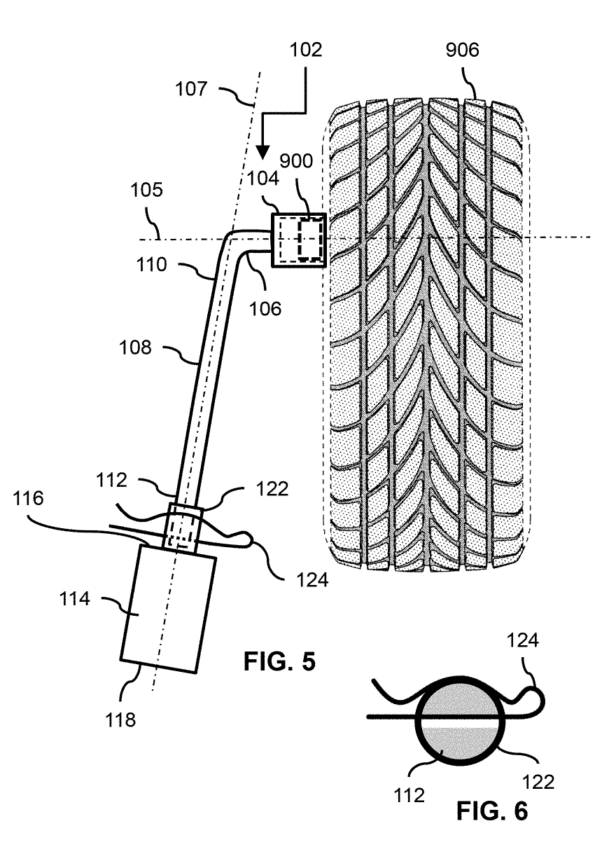

FIG. 5 and FIG. 6 depict a top view and a cross-sectional view (respectively) of embodiments of the apparatus of FIG. 1.

In accordance with the embodiment as depicted in FIG. 5 and FIG. 6, the step-pad assembly 114 further includes a connector 124 configured to selectively securely connect (couple) the step-pad assembly 114 to the linearly-extended elongated shaft portion 108 (to the second end portion 112 of the linearly-extended elongated shaft portion 108). For instance, the linearly-extended elongated shaft portion 108 defines a hole 126 configured to receive the connector 124. By way of example, the connector 124 includes a cotter pin, etc., and any equivalent thereof (such as a bolt and nut combination, etc.). In this arrangement, the step-pad assembly 114 and the linearly-extended elongated shaft portion 108 are configured (arranged) as a two-piece design, so that the step-pad assembly 114 may be selectively detachable from the linearly-extended elongated shaft portion 108.

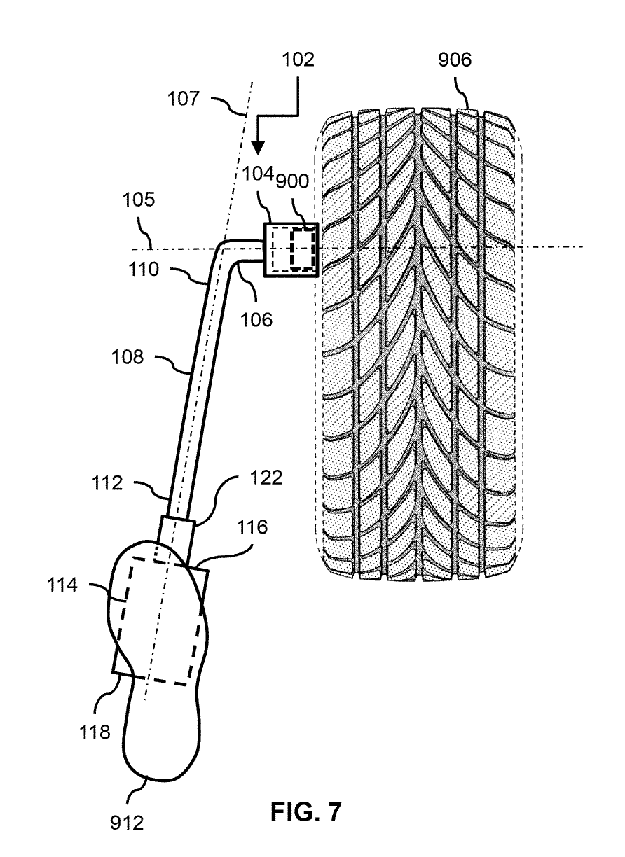

FIG. 7 depicts a top view of an embodiment of the apparatus of FIG. 1.

In accordance with the embodiment as depicted in FIG. 7, the foot 912 of the user steps on the step-pad assembly 114, and pushes the step-pad assembly 114 downwardly in order to apply torque force to the nut 900 (as previously described).

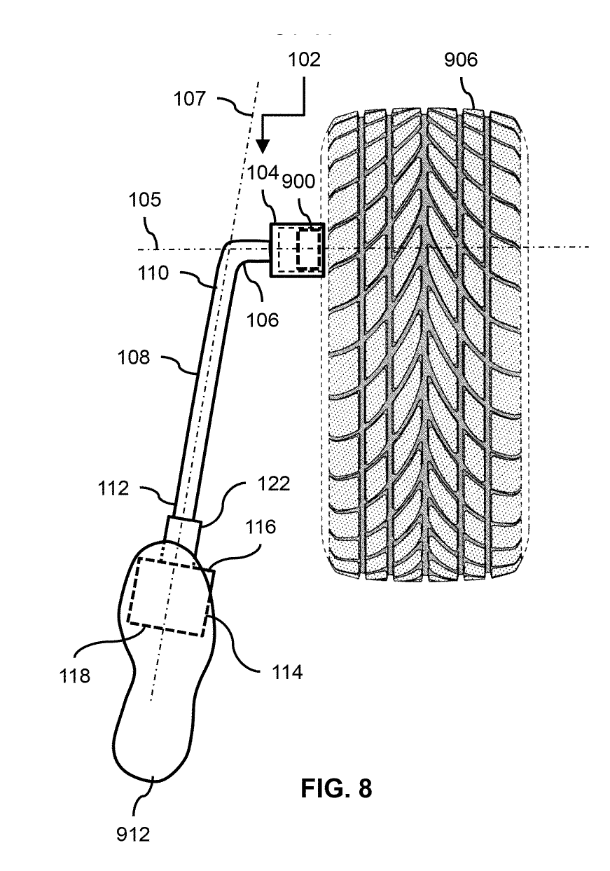

FIG. 8 depicts a top view of an embodiment of the apparatus of FIG. 1.

In accordance with the embodiment as depicted in FIG. 8, the step-pad assembly 114 is sized or dimensioned to receive the ball of the foot 912.

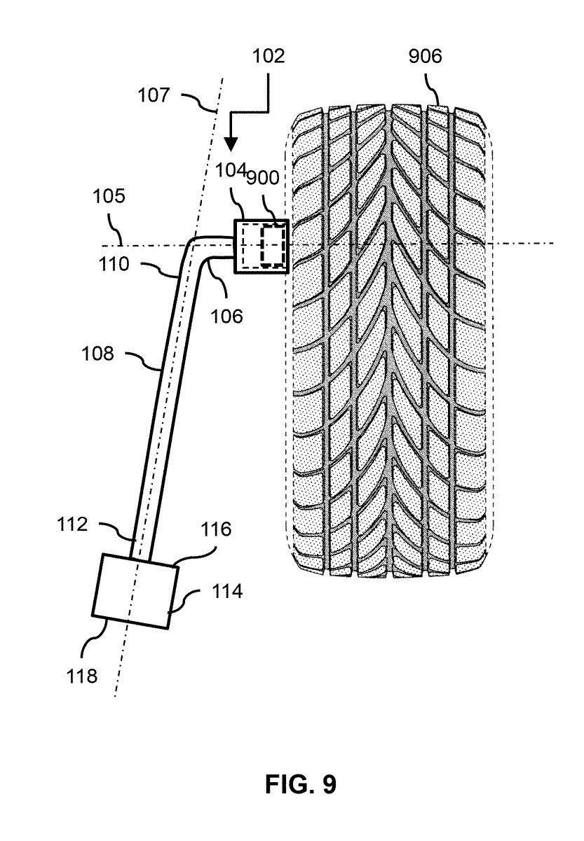

FIG. 9 depicts a top view of an embodiment of the apparatus of FIG. 1.

In accordance with the embodiment as depicted in FIG. 9, the step-pad assembly 114 and the linearly-extended elongated shaft portion 108 are integrally connected as a single unitary piece.

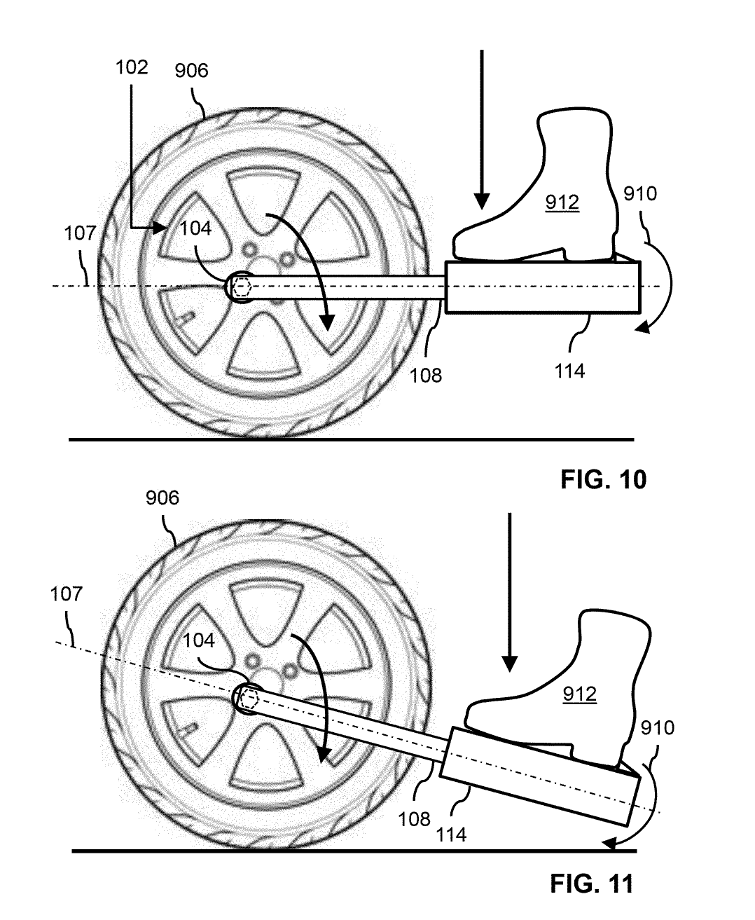

FIG. 10 and FIG. 11 depict side views of embodiments of the apparatus of FIG. 1.

The tool device 104 is installed to the nut of the wheel 906 (as depicted in FIG. 10).

The user steps on the step-pad assembly 114 (as depicted in FIG. 10). As depicted in FIG. 11, the user applies a downward force on the step-pad assembly 114, and thereby the user imparts (in use) the torque 910 to the linearly-extended elongated shaft portion 108 (this is done in such a way that the torque 910 (that is applied) may be used to either tighten or loosen the nut installed to the wheel 906).

In accordance with the embodiments as depicted in FIGS. 10 and 11, the step-pad assembly 114 and the linearly-extended elongated shaft portion 108 are co-axially aligned with each other along the pivot axis 107.

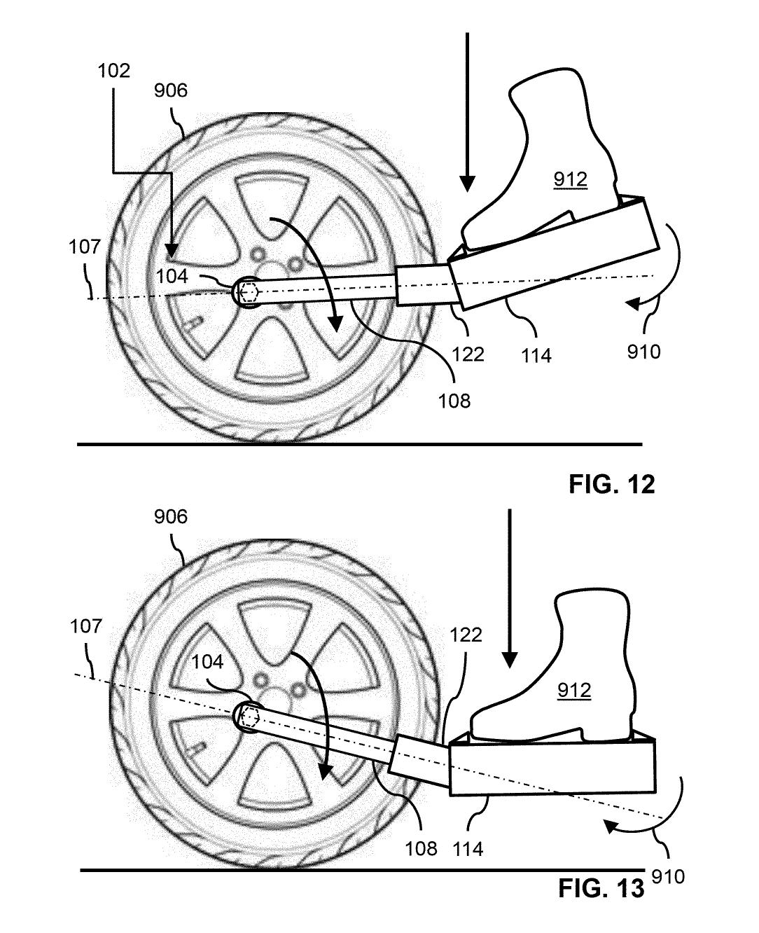

FIG. 12 and FIG. 13 depict side views of embodiments of the apparatus of FIG. 1.

In accordance with the embodiments as depicted in FIGS. 12 and 13, the step-pad assembly 114 and the linearly-extended elongated shaft portion 108 are not co-axially aligned with each other along the pivot axis 107.

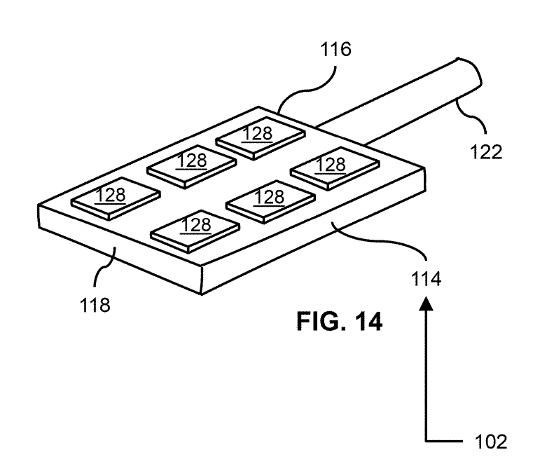

FIG. 14 depicts a frontal perspective view of an embodiment of the apparatus of FIG. 1.

In accordance with the embodiment as depicted in FIG. 14, the step-pad assembly 114 includes spaced apart projections 128 that extend from the surface of the step-pad assembly 114. The plurality of the spaced apart projections 128 may have any suitable shape. The spaced apart projections 128 is configured to facilitate frictional fit between the bottom of the foot (or shoe) of the user and the step-pad assembly 114 (to thereby reduce the possibility of inadvertent slippage between the foot of the user and the step-pad assembly 114).

In accordance with the embodiment as depicted in FIG. 14, the collar portion 122 extends from the step-pad assembly 114 in such a way that the collar portion 122 and the step-pad assembly 114 remain (stay) on the same plane.

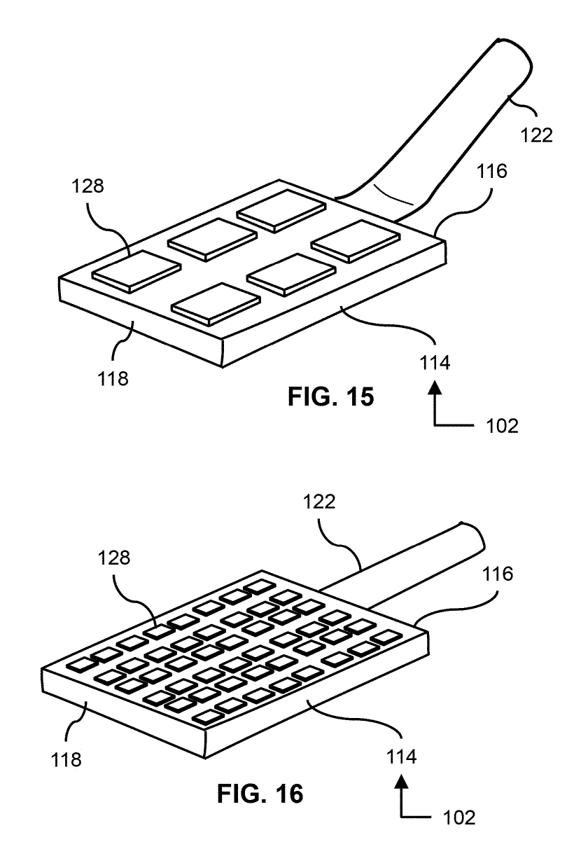

FIG. 15 and FIG. 16 depict frontal perspective views of embodiments of the apparatus of FIG. 1.

In accordance with the embodiment as depicted in FIG. 15, the collar portion 122 extends from the step-pad assembly 114 at an angle (in such a way that the collar portion 122 and the step-pad assembly 114 do not remain or stay on the same plane).

In accordance with the embodiment as depicted in FIG. 16, the spaced apart projections 128 are sized to be relatively smaller for improved secured contact between the step-pad assembly 114 and the bottom of the shoe of the user.

It will be appreciated that the description identifies and describes options and variations of the apparatus, regardless of whether the description identifies the options and/or variations of the apparatus by way of explicit terms and/or non-explicit terms. Other options for the apparatus as identified in this paragraph may include any combination and/or permutation of the technical features (assemblies, components, items, devices, etc.) as identified in the detailed description, as may be required and/or desired to suit a particular technical purpose and/or technical function. It will be appreciated, that where possible, any one or more of the technical features and/or any one or more sections of the technical features of the apparatus may be combined with any other one or more of the technical features and/or any other one or more sections of the technical features of the apparatus in any combination and/or permutation. Any one or more of the technical features and/or any one or more sections of the technical features of the apparatus may stand on its own merit without having to be combined with another technical feature. It will be appreciated that persons skilled in the art would know that technical features of each embodiment may be deployed (where possible) in other embodiments even if not expressly stated as such above. It will be appreciated that persons skilled in the art would know that other options would be possible for the configuration of the components of the apparatus (if so desired) to adjust to manufacturing requirements and still remain within the scope of the invention as described in at least one or more of the claims. This written description uses examples to disclose the invention, including the best mode, and also to enable any person skilled in the art to make and use the invention. The patentable scope of the invention is defined by the claims, and may include other examples that occur to those skilled in the art. Such other examples are within the scope of the claims if they have structural elements that do not differ from the literal language of the claims, or if they include equivalent structural elements with insubstantial differences from the literal language of the claims. It may be appreciated that the assemblies and modules described above may be connected with each other as required to perform desired functions and tasks within the scope of persons of skill in the art to make such combinations and permutations without having to describe each and every one in explicit terms. There is no particular assembly or component that may be superior to any of the equivalents available to the person skilled in the art. There is no particular mode of practicing the disclosed subject matter that is superior to others, so long as the functions may be performed. It is believed that all the crucial aspects of the disclosed subject matter have been provided in this document. It is understood that the scope of the present invention is limited to the scope provided by the independent claim(s), and it is also understood that the scope of the present invention is not limited to: (i) the dependent claims, (ii) the detailed description of the non-limiting embodiments, (iii) the summary, (iv) the abstract, and/or (v) the description provided outside of this document (that is, outside of the instant application as filed, as prosecuted, and/or as granted). It is understood, for this document, that the phrase “includes” is equivalent to the word “comprising.” The foregoing has outlined the non-limiting embodiments (examples). The description is made for particular non-limiting embodiments (examples). It is understood that the non-limiting embodiments are merely illustrative as examples.

What is claimed is:

1. An apparatus, comprising:
a tool assembly, including:
a tool device being configured to securely receive, at least in part, a nut; and
an angled elbow assembly being configured to be positioned proximate to, and securely integrally extended from, the tool device; and
a linearly-extended elongated shaft portion being configured to have a first end portion and a second end portion being spaced apart from the first end portion; and
a step-pad assembly, including:
a first side portion facing the second end portion of the linearly-extended elongated shaft portion; and
a second side portion being configured to extend from the first side portion in such a way that the linearly-extended elongated shaft portion does not extend through the step-pad assembly and out from the second side portion of the step-pad assembly.

2. The apparatus of claim 1, wherein:
the step-pad assembly includes the first side portion, and the second side portion being spaced apart from the first side portion; and
the step-pad assembly defines a bore extending partway into the step-pad assembly; and
the bore extending from the first side portion of the step-pad assembly and into the interior of the step-pad assembly; and
the bore does not extend and reach the second side portion of the step-pad assembly.

3. The apparatus of claim 2, wherein:
the second end portion of the linearly-extended elongated shaft portion is configured to be received, at least in part, into the bore of the step-pad assembly.

4. The apparatus of claim 2, wherein:
the second end portion of the linearly-extended elongated shaft portion is configured to be slidably received, at least in part, into the bore of the step-pad assembly.

5. The apparatus of claim 2, wherein:
the second end portion of the linearly-extended elongated shaft portion defines a tapered end section; and
the bore defines a tapered shape that conforms to a shape of the tapered end section of the second end portion.

6. The apparatus of claim 2, wherein:
the second end portion provides a tapered end section that is configured to be friction fitted with the bore of the step-pad assembly.

7. The apparatus of claim 1, wherein:
the second end portion is permanently affixed to the step-pad assembly.

8. The apparatus of claim 1, wherein:
the step-pad assembly includes a unitary solid body member having a width, height and length; and
the unitary solid body member has a top surface and a bottom surface defining a height of a solid body member, in which the height of the unitary solid body member of the step-pad assembly is any one of equal to and greater than the height of the linearly-extended elongated shaft portion.

9. The apparatus of claim 1, wherein:
the step-pad assembly is fixedly attached to the linearly-extended elongated shaft portion; and
the step-pad assembly is not detachable from the linearly-extended elongated shaft portion.

10. The apparatus of claim 1, wherein:
the step-pad assembly includes a collar portion extending outwardly from the step-pad assembly; and
the collar portion being configured to receive the second end portion of the linearly-extended elongated shaft portion; and
the collar portion defining a bore; and
the step-pad assembly does not define the bore; and
the second end portion of the linearly-extended elongated shaft portion is configured to be received, at least in part, into the bore of the collar portion.

11. The apparatus of claim 1, wherein:
the step-pad assembly further includes a connector being configured to selectively securely connect the step-pad assembly to the linearly-extended elongated shaft portion.

12. The apparatus of claim 11, wherein:
the linearly-extended elongated shaft portion defines a hole configured to receive the connector.

13. The apparatus of claim 11, wherein:
the step-pad assembly and the linearly-extended elongated shaft portion are integrally connected as a single unitary piece.

14. The apparatus of claim 11, wherein:
the step-pad assembly and the linearly-extended elongated shaft portion are co-axially aligned with each other along a pivot axis.

15. The apparatus of claim 11, wherein:
the step-pad assembly and the linearly-extended elongated shaft portion are not co-axially aligned with each other along a pivot axis.

16. The apparatus of claim 11, wherein:
the step-pad assembly includes spaced apart projections that extend from a surface of the step-pad assembly; and
the spaced apart projections are configured to facilitate frictional fit between the bottom of a foot of a user and the step-pad assembly, thereby reducing, at least in part, a possibility of inadvertent slippage between the foot of the user and the step-pad assembly.

17. The apparatus of claim 10, wherein:
the collar portion extends from the step-pad assembly in such a way that the collar portion and the step-pad assembly remain on the same plane.

18. The apparatus of claim 10, wherein:
the collar portion extends from the step-pad assembly at an angle in such a way that the collar portion and the step-pad assembly do not remain on the same plane.

19. An apparatus, comprising:
a tool assembly, including:
a step-pad assembly configured for use with (A) a tool device configured to securely receive, at least in part, a nut, (B) an angled elbow assembly configured to be positioned proximate to, and securely integrally extended from, the tool device, and (C) a linearly-extended elongated shaft portion configured to have a first end portion and a second end portion spaced apart from the first end portion; and
the step-pad assembly, including:
a first side portion configured to face the second end portion of the linearly-extended elongated shaft portion; and
a second side portion being configured to extend from the first side portion in such a way that the linearly-extended elongated shaft portion does not extend through the step-pad assembly and out from the second side portion of the step-pad assembly.

20. An apparatus, comprising:
a tool assembly, including:
a tool device being configured to have a rotation axis extending therethrough, in which the tool device is rotatable about the rotation axis; and
the tool device also being configured to securely receive, at least in part, a nut mounted to a wheel bolt of a wheel of a vehicle; and
the tool device also being configured to rotate the nut mounted to the wheel bolt in response to rotation of the tool device about the rotation axis of the tool device; and
an angled elbow assembly being configured to be positioned proximate to, and securely integrally extended from, the tool device in such a way that the rotation axis of the tool device extends, at least in part, through the angled elbow assembly; and
the angled elbow assembly also being configured to have a pivot axis extending therefrom in such a way that the pivot axis and the rotation axis of the tool device intersect each other at a predetermined angle; and
a linearly-extended elongated shaft portion being configured to have a first end portion and a second end portion being spaced apart from the first end portion, in which the first end portion securely integrally extends from the angled elbow assembly along the pivot axis of the angled elbow assembly; and
a step-pad assembly being configured to extend from the second end portion of the linearly-extended elongated shaft portion along the pivot axis extending through the linearly-extended elongated shaft portion in such a way that the step-pad assembly is extended and aligned in-line with the pivot axis extending through the linearly-extended elongated shaft portion; and
the step-pad assembly also being configured to axially receive the second end portion of the linearly-extended elongated shaft portion, in which the second end portion is spaced apart from the angled elbow assembly; and
the step-pad assembly also being configured to securely receive an application of a torque from a foot of a user in such a way that the step-pad assembly securely receives the torque from the foot of the user without inadvertent slippage between the foot of the user and the step-pad assembly; and
the step-pad assembly also being configured to securely receive the application of the torque from the foot of the user in such a way that the step-pad assembly conveys the torque, which was received from the foot of the user, to the linearly-extended elongated shaft portion, without inadvertent slippage between the foot of the user and the step-pad assembly, and while the torque is transmitted to the linearly-extended elongated shaft portion; and
the step-pad assembly also being configured to securely receive the application of the torque from the foot of the user in such a way that (A) the linearly-extended elongated shaft portion is rotatable, once the torque is received from the step-pad assembly, about the pivot axis, and (B) the angled elbow assembly and the tool device and the nut, which is received by the tool device, rotate without inadvertent slippage between the foot of the user and the step-pad assembly, while the linearly-extended elongated shaft portion rotates about the pivot axis, and while the angled elbow assembly and the tool device and the nut, which is received by the tool device, rotate; and
the step-pad assembly, including:
a first side portion facing the second end portion of the linearly-extended elongated shaft portion; and
a second side portion being spaced apart from the first side portion; and
the second side portion being positioned opposite from the first side portion across from the step-pad assembly; and
the second side portion facing away from the second end portion of the linearly-extended elongated shaft portion; and
the second end portion of the linearly-extended elongated shaft portion being configured to extend from the first side portion in such a way that the linearly-extended elongated shaft portion does not extend through the step-pad assembly and out from the second side portion of the step-pad assembly.
